(19) United States
(12) Patent Application Publication
(10) Pub. No.: US 2012/0239897 A1
(43) Pub. Date: Sep. 20, 2012

(54) STORAGE APPARATUS, METHOD FOR MOVING DATA, AND STORAGE SYSTEM

(75) Inventor: Katsuya NIIGATA, Kawasaki (JP)

(73) Assignee: FUJITSU LIMITED, Kawasaki-shi (JP)

(21) Appl. No.: 13/351,491

(22) Filed: Jan. 17, 2012

(30) Foreign Application Priority Data
Mar. 18, 2011 (JP) 2011-060947

(51) Int. Cl. G06F 12/02

(52) U.S. Cl. 711/165; 711/E12.002

(57) ABSTRACT

A storage apparatus includes a storage unit that stores received data, an investigation frame transmission unit that transmits investigation frames to a plurality of other storage apparatuses connected through a communication network, a performance information creation unit that creates performance information for the plurality of other storage apparatuses on the basis of reception results of response frames transmitted in response to the investigation frames, a destination determination unit that determines a destination storage apparatus from among the plurality of other storage apparatuses on the basis of the created performance information, and a movement process unit that executes a movement process in which the data is moved from the storage unit to the destination storage apparatus.

### CROSS-REFERENCE TO RELATED APPLICATIONS

This application is based upon and claims the benefit of priority of the prior Japanese Patent Application No. 2011-60947, filed on Mar. 18, 2011, the entire contents of which are incorporated herein by reference.

### FIELD

The embodiments discussed herein are related to a storage apparatus, a method for moving data, and a storage system.

### BACKGROUND

FIG. 12 is a diagram schematically illustrating the configuration of a storage system. A storage system 500 illustrated in FIG. 12 is a storage pool including a plurality of storage apparatuses 5 and connected to a host apparatus 503. The storage system 500 reads and writes data from and to the storage apparatuses 5 included in the storage pool in accordance with reading and writing commands from the host apparatus 503.

In the storage system 500, the plurality of storage apparatuses 5 are connected to one another through a network 502 in such a way as to enable communication. The storage apparatuses 5 are, for example, apparatuses adopting Redundant Arrays of Inexpensive Disks (RAID).

In such a storage system 500, there may be a case in which data stored in a particular storage apparatus 5 needs to be moved to another storage apparatus 5 for a reason such as convenience of operation. Currently, a destination storage apparatus 5 is selected on the basis of, for example, performance such as the storage capacity of the storage apparatuses 5, and movement of data is performed (refer to Japanese Laid-open Patent Publication No. 2007-058637).

In the method for moving data in the storage system according to the example of the related art, however, data might be moved to a storage apparatus 5 whose latency in relation to the host apparatus 503 is high. In such a storage apparatus 5 whose latency is high, timeout might be undesirably generated during data access from the host apparatus 503.

### SUMMARY

According to an aspect of the invention, a storage apparatus includes a storage unit that stores received data, an investigation frame transmission unit that transmits investigation frames to a plurality of other storage apparatuses connected through a communication network, a performance information creation unit that creates performance information for the plurality of other storage apparatuses on the basis of reception results of response frames transmitted in response to the investigation frames, a destination determination unit that determines a destination storage apparatus from among the plurality of other storage apparatuses on the basis of the created performance information, and a movement process unit that executes a movement process in which the data is moved from the storage unit to the destination storage apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating the functional configuration of a storage system as an example of a first embodiment.

FIG. 2 is a diagram schematically illustrating the hardware configuration of the storage system as an example of the first embodiment.

FIG. 3 is a diagram schematically illustrating the hardware configuration of a storage apparatus in the storage system as an example of the first embodiment.

FIG. 4 is a diagram illustrating an example of processing capabilities in the storage system as an example of the first embodiment.

FIG. 5 is a diagram illustrating an example of performance information in the storage system as an example of the first embodiment.

FIG. 6 is a diagram illustrating a method for measuring latency in the storage system as an example of the first embodiment.

FIG. 7 is a diagram illustrating a range policy in the storage system as an example of the first embodiment.

FIG. 8 is a flowchart illustrating a process executed by the storage apparatus in the storage system as an example of the first embodiment.

FIG. 9 is a diagram illustrating an example of the performance information in the storage system as an example of the first embodiment.

FIG. 10 is a diagram illustrating an example of the performance information in a storage system as an example of a second embodiment.

FIG. 11 is a diagram illustrating a method for using latency as the range policy in the storage system as an example of the second embodiment.

FIG. 12 is a diagram schematically illustrating the configuration of a storage system as an example of a related art.

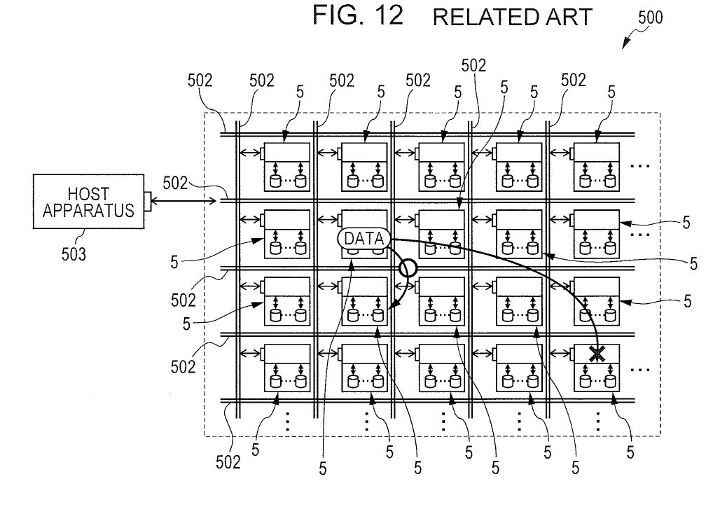

### DESCRIPTION OF EMBODIMENTS

Embodiments relating to a storage apparatus, a method for moving data, and a storage system in the present invention will be described hereinafter with reference to the drawings. However, the embodiments that will be described hereinafter are just examples, and not intended to exclude various modifications and applications of the technique that are not specified in the embodiments. That is, the embodiments may be modified in various ways and implemented, insofar as the scope of the present invention is not deviated from.

### First Embodiment

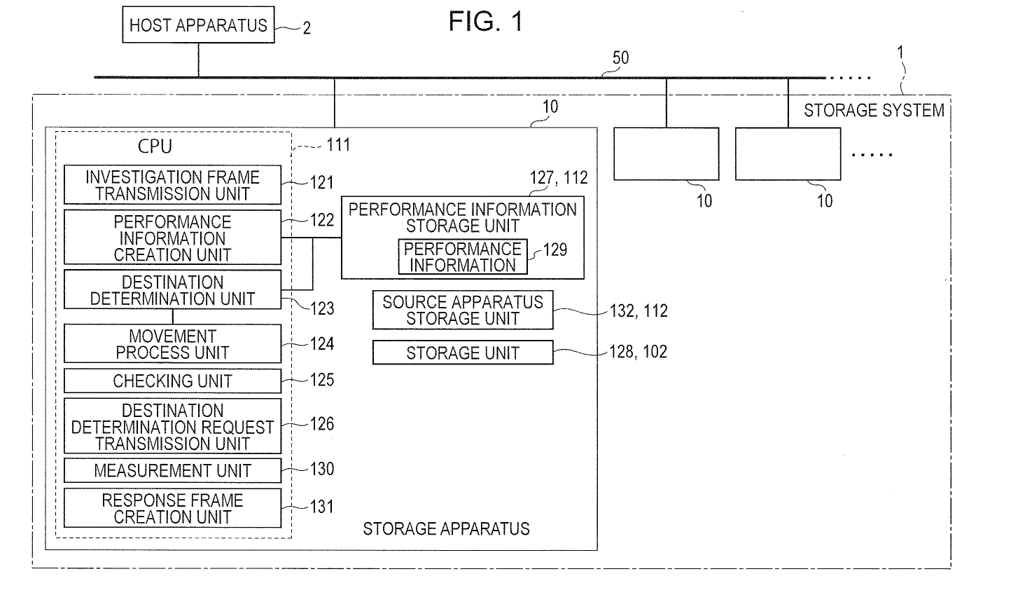

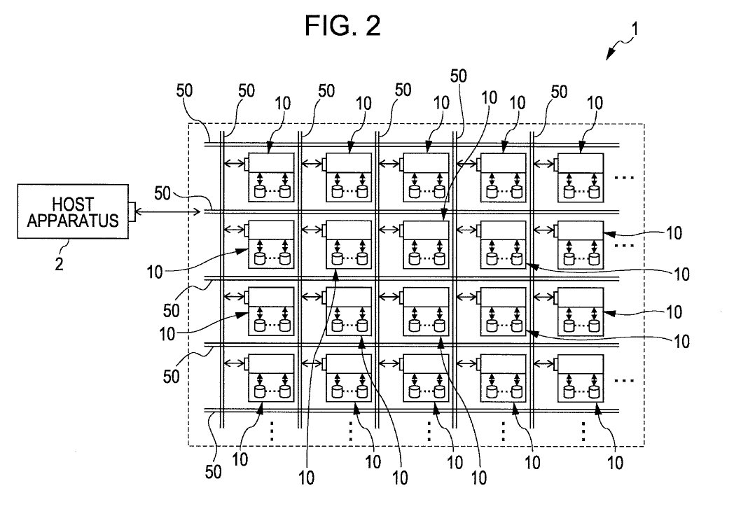

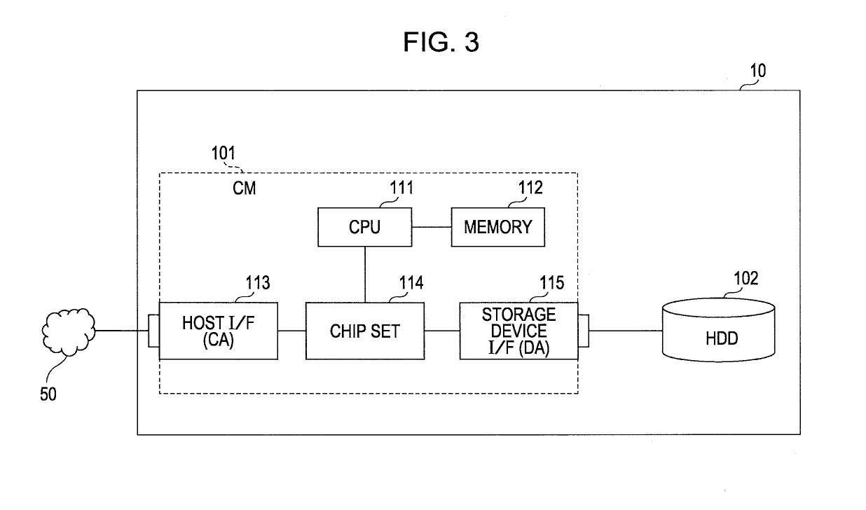

FIG. 1 is a diagram schematically illustrating the functional configuration of a storage system 1 as an example of a first embodiment. FIG. 2 is a diagram schematically illustrating the hardware configuration of the storage system 1. FIG. 3 is a diagram schematically illustrating the hardware configuration of a storage apparatus 10 in the storage system 1.

As illustrated in FIGS. 1 and 2, the storage system 1 according to the first embodiment has a plurality of storage apparatuses 10 and connected to one or more (one in the example illustrated in FIG. 1) host apparatuses 2 in such a way as to enable communication.

The storage apparatuses 10 provide storage regions for the host apparatus 2 and connected to one another through a communication network 50 in such a way as to enable communication. In the storage system 1, each storage apparatus 10 is configured to have the same or substantially the same functional configuration and hardware configuration.

In the first embodiment, an example will be described in which data stored in one of the storage apparatuses 10 is moved to another storage apparatus 10. In the following description, a storage apparatus 10 from which data is moved may be called the “transmission apparatus 10” or the “source storage apparatus 10”. In addition, in the following description, storage apparatuses 10 other than the transmission apparatus 10 may be called the “reception apparatuses 10” or “destination storage apparatus 10”.

In the example illustrated in FIG. 1, the functional configuration of only one of the plurality of storage apparatuses 10 is illustrated for convenience sake.

As illustrated in FIG. 3, the storage apparatus 10 has a controller module (CM) 101 and a hard disk drive (HDD: a storage device) 102.

The HDD 102 is a storage device that stores data such that the data can be read and written, and functions as a storage unit 128 that stores data received from the host apparatus 2 (refer to FIG. 1). It is to be noted that although a single HDD 102 is included in the storage apparatus 10 in FIG. 3, the number of HDDs 102 is not limited to this, and two or more HDDs 102 may be included. In that case, the storage apparatus 10 may be an apparatus adopting RAID in which the plurality of HDDs 102 are combined with one another and managed as a single redundant storage.

The CM 101 is a controller that controls operations in the storage apparatus 10 and receives commands such as reading and writing from the host apparatus 2, in order to perform various types of control. The CM 101 is connected to the communication network 50 through a host interface (I/F) 113 and receives the commands such as reading and writing transmitted from the host apparatus 2, in order to control the HDD 102 through a storage device interface (I/F) 115.

As illustrated in FIG. 3, the CM 101 has the host interface 113, the storage device interface 115, a central processing unit (CPU) 111, a memory 112, and a chip set 114.

The host interface 113 is an interface controller that is connected to the host apparatus 2 through the communication network 50 in such a way as to enable communication, and controls input and output of data from and to the host apparatus 2. The host interface 113 is, for example, a channel adapter (CA). The CM 101 is connected to the communication network 50 through the host interface 113.

The storage device interface 115 is an interface controller that is connected to the HDD 102, and is, for example, a device adapter (DA). The CM 101 writes and reads data to and from the HDD 102 through the storage device interface 115.

The chip set 114 controls transmission and reception of data between the CPU 111, the host interface 113, and the storage device interface 115.

The memory 112 is a storage region that temporarily stores various pieces of data and programs and is used to, when the CPU 111 executes a program, temporarily store and expand data and the program. The memory 112 also stores performance information 129 created by a performance information creation unit 122, which will be described later, and functions as a performance information storage unit 127 (refer to FIG. 1). In addition, the memory 112 also stores source apparatus information, which will be described later, and functions as a source apparatus storage unit 132 (refer to FIG. 1). Furthermore, the memory 112 stores an investigation frame transmitted by an investigation frame transmission unit 121, which will be described later.

In the storage system 1, identification information for identifying each storage apparatus 10 is set in advance. The identification information is recorded in a certain region (for example, the memory 112, the HDD 102, or a nonvolatile memory, which is not illustrated) of each storage apparatus 10. As the identification information, an identification (ID) that is unique to each storage apparatus 10 may be appropriately set and used, or information such as a Media Access Control (MAC) address may be appropriately utilized.

The CPU 111 is a processing device that performs various types of control and calculations and realizes various functions by executing programs stored in a read-only memory (ROM), which is not illustrated, or the like. By executing control programs, the CPU 111 functions as the investigation frame transmission unit 121, the performance information creation unit 122, a destination determination unit 123, a movement process unit 124, a checking unit 125, a destination determination request transmission unit 126, a measurement unit 130, and a response frame creation unit 131, as illustrated in FIG. 1.

The programs (control programs) for realizing the functions as the investigation frame transmission unit 121, the performance information creation unit 122, the destination determination unit 123, the movement process unit 124, the checking unit 125, the destination determination request transmission unit 126, the measurement unit 130, and the response frame creation unit 131 are provided as recorded on a recording medium that can be read by a computer, such as, for example, a flexible disk, a compact disc (CD) (a compact disc read-only memory (CD-ROM), a compact disc recordable (CD-R), a compact disc rewritable (CD-RW), or the like), a digital versatile disc (DVD) (a digital versatile disc read-only memory (DVD-ROM), a digital versatile disc random-access memory (DVD-RAM), a digital versatile disc recordable (DVD-R), a DVD+R, digital versatile disc rewritable (DVD-RW), a DVD+RW, a high-definition digital versatile disc (HD DVD), or the like), a Blu-ray Disc (registered trademark), a magnetic disk, an optical disk, or a magneto-optical disk. The computer reads a program from the recording medium and uses the program by transferring the program to an internal storage device or an external storage device and by storing the program in the internal storage device or the external storage device. Alternatively, the program may be recorded on a storage device (recording medium) such as, for example, a magnetic disk, an optical disk, or a magneto-optical disk and provided for the computer from the storage device through a communication path.

When the function as the investigation frame transmission unit 121, the performance information creation unit 122, the destination determination unit 123, the movement process unit 124, the checking unit 125, the destination determination request transmission unit 126, the measurement unit 130, or the response frame creation unit 131 is realized, a program stored in an internal storage device (the memory 112 or the ROM, which is not illustrated) is executed by a microprocessor (the CPU 111, in this embodiment) of the computer. At this time, the computer may read a program recorded on a recording medium and execute the program.

In this embodiment, a “computer” is a concept that includes hardware and an operating system and refers to hardware that operates under the control of an operating system. When an operating system is not necessary and hardware is operated solely by an application program, the hardware itself corresponds to the computer. The hardware has at least a microprocessor such as a CPU and means for reading a computer program recorded on a recording medium. In this embodiment, the CM 101 has the function as a computer.

The investigation frame transmission unit 121 transmits investigation frames to a plurality of other storage apparatuses 10 connected through the communication network 50. The investigation frames are instruction information for causing storage apparatuses 10 that have received the investigation frames to create and send back response frames, and configured as, for example, data strings having a certain format.

The investigation frame transmission unit 121 issues the investigation frames to all the other storage apparatuses 10 in a storage pool connected through the communication network 50 using, for example, broadcast.

The investigation frame transmission unit 121 transmits, for example, data of the investigation frames prepared in the memory 112 to the communication network 50 through the chip set 114 and the host interface 113.

The investigation frames cause the storage apparatuses (reception apparatuses) 10 that have received the investigation frames to investigate the processing capabilities and status information of the storage apparatuses 10.

The processing capabilities include, for example, the type of RAID (RAID type), the Input/Output Operations Per Second (IOPS), and the throughput of each reception apparatus 10, and the status information includes, for example, the amount of available memory of the HDD 102 included in each reception apparatus 10.

The IOPS herein refers to the number of times data having a certain size can be read or written in one second. The higher the IOPS, the higher the processing capabilities. The throughput is the amount of data that can be moved in one second and, for example, B/s is used as the unit thereof. The values of the IOPS and the throughput may significantly vary depending on conditions such as reading or writing, the size of data, and the RAID type, and may be appropriately changed and used.

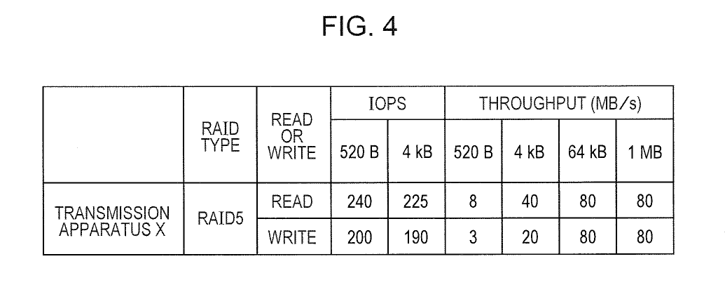

FIG. 4 is a diagram illustrating the processing capabilities of the storage system 1 as an example of the first embodiment.

FIG. 4 illustrates an example of the processing capabilities of a transmission apparatus 10-X (illustrated as transmission apparatus X in FIG. 4), which is represented as a table in which the RAID type, the IOPS, and the throughput are associated with one another. In addition, in the example illustrated in FIG. 4, the IOPS and the throughput are provided for each of reading and writing. Furthermore, in the example illustrated in FIG. 4, IOPSs for two types of data sizes, namely 520 B and 4 kB, are provided and throughputs for four types of data sizes, namely 520 B, 4 kB, 64 kB and 1 MB, are provided.

An investigation frame causes a reception apparatus 10 that has received the investigation frame to create a response frame storing processing capability information indicating the processing capabilities of the reception apparatus 10 and status information and to send the response frame back to a storage apparatus (transmission apparatus) 10 that has transmitted the investigation frame.

For example, an investigation frame is configured to have a particular format that has been defined in advance. When a reception apparatus 10 has received the investigation frame, the investigation frame causes the reception apparatus 10 to execute a function of investigating the processing capabilities and the status information of the reception apparatus 10, a function of creating a response frame, and a function of transmitting the response frame. The investigation frame may be configured as a combination between an investigation instruction command, a creation instruction command, and a transmission instruction command that cause the storage apparatus 10 that has received the investigation frame to investigate the processing capabilities, create a response frame, and transmit the response frame, respectively.

The transmission of the investigation frame performed by the investigation frame transmission unit 121 is performed on the basis of a data movement start instruction. The data movement start instruction is generated when, for example, generation of an event that satisfies a movement start condition, under which movement of data is begun, has been detected in a particular piece of data in the storage system 1. The movement start condition may be, for example, a case in which the use rate of data exceeds a predetermined threshold value.

That is, in the storage apparatus 10, the CPU 111 (an operation monitoring unit) monitors the operation status of the HDD 102 and compares, with regard to data stored in the HDD 102, the use rate (the use rate of the data) with the predetermined threshold value. When the CPU 111 (a movement process determination unit) has detected that the use rate of the data has exceeded the threshold value, the CPU 111 determines to execute a movement process in which the data is moved to another storage apparatuses 10.

It is to be noted that the movement start condition is not limited to the use rate of data, and may be changed in various ways. That is, the present invention is not limited to a case in which, as described above, the operation monitoring unit monitors whether or not the movement start condition has been satisfied and the movement process determination unit automatically starts the movement of data on the basis of a result of the monitoring in each storage apparatus 10. For example, an operator of the storage system 1 or the like may manually input a data movement instruction (a movement instruction), and upon detecting the input of the movement instruction, the movement process determination unit may determine to execute the movement process. More specifically, the movement of data may be performed by the operator or the like by identifying data to be moved and inputting a start instruction of the movement of the data using a terminal apparatus (not illustrated) connected to the communication network 50 in such a way as to enable communication.

The performance information creation unit 122 receives a response frame transmitted from each of the other storage apparatuses 10 in response to each investigation frame transmitted by the investigation frame transmission unit 121 and creates the performance information 129 on the basis of the response frame.

Each response frame is received by the host interface 113 through the communication network 50 and then received by the performance information creation unit 122 (the CPU 111) through the chip set 114.

In each response frame, the processing capability information indicating the performance of each of the other storage apparatuses 10 and the status information are stored in predetermined positions, and the performance information creation unit 122 reads these pieces of information from each response frame. The performance information creation unit 122 then creates the performance information 129 using these pieces of information.

The performance information 129 is information indicating the performance of each of the other storage apparatuses 10 and includes transmission capability information, the processing capability information, and the status information. The transmission capability information indicates a capability of transmitting data between a transmission apparatus and a reception apparatus. The processing capability information is the capabilities of the reception apparatus to process data. The status information is information indicating the status of the reception apparatus.

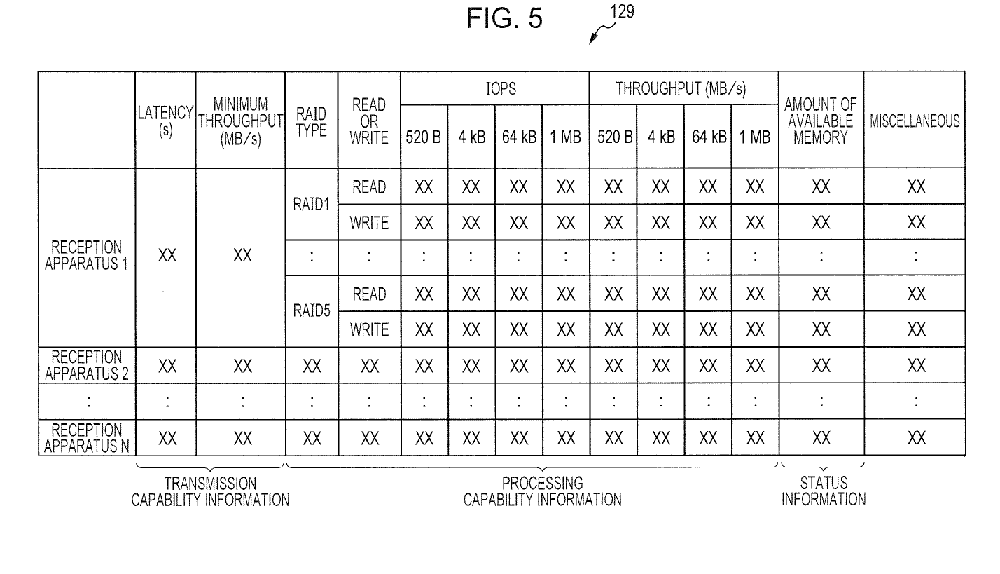

FIG. 5 is a diagram illustrating an example of the performance information 129 of the storage system 1 as an example of the first embodiment. In the example illustrated in FIG. 5, the performance information 129 is configured as a table (an other apparatuses table) in which latency, minimum throughput, IOPS, throughput, the amount of available memory, and other pieces of information are associated with one another for each of reception apparatuses 10-1 to 10-N (reception apparatuses 1 to N in FIG. 5). In FIG. 5, each value is expressed as “XX” for convenience sake. In practice, various values are stored instead of “XX”.

In the performance information 129 illustrated in FIG. 5, the latency and the minimum throughput are the transmission capability information and the IOPS and the throughput are the processing capability information. In addition, the amount of available memory is the status information.

In the performance information 129 illustrated in FIG. 5, the IOPS and the throughput are provided for each of reading and writing in each RAID type. In the example illustrated in FIG. 5, too, as with the processing capabilities illustrated in FIG. 4, the IOPSs for the two types of data sizes, namely 520 B and 4 kB, are provided and the throughputs for the four types of data sizes, namely 520 B, 4 kB, 64 kB, and 1 MB, are provided. It is to be noted that, in the example illustrated in FIG. 5, the IOPS, the throughput, the amount of available memory, and the like for each of reading and writing in each RAID type are provided for only the reception apparatus 10-1 for convenience sake. In practice, however, with respect to the other reception apparatuses 10-2 to 10-N, too, these pieces of information are provided for each of reading and writing in each RAID type.

Latency is time required to transmit a frame between the host apparatus 2 and a storage apparatus 10.

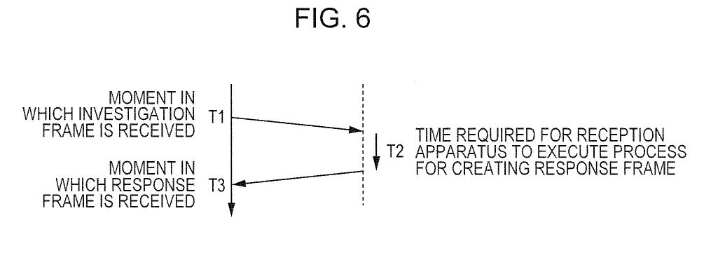

FIG. 6 is a diagram illustrating a method for measuring the latency in the storage system 1 as an example of the first embodiment. In the example illustrated in FIG. 6, the latency is obtained by the following expression (1):

Latency=[(T3−T1)−T2]/2 (1)

In the above expression, “T3” is a moment in which the transmission apparatus 10 has received a response frame, “T1” is a moment in which the transmission apparatus 10 has transmitted an investigation frame, and “T2” is time required for a reception apparatus 10 to execute a process for creating the response frame. The time T2 required for the reception apparatus 10 to execute the process for creating the response frame is measured in the reception apparatus 10 itself. The time T2 is then added to the response frame as notification information and transmitted to the transmission apparatus 10.

The minimum throughput is obtained by the following expression (2):

Minimum throughput=(Data size of investigation frame+Data size of response frame)/Latency (2)

The latency and the minimum throughput correspond to the transmission capability information indicating the transmission capabilities of the transmission apparatus 10 and the other storage apparatuses (the reception apparatuses) 10 on the communication network 50.

The latency and the minimum throughput are calculated by the performance information creation unit 122.

The IOPS and the throughput correspond to the processing capability information indicating the processing capabilities of the other storage apparatuses 10. The amount of available memory is the amount of available memory of the HDD 102 of each of the other storage apparatuses 10 and corresponds to the status information.

The performance information creation unit 122 need not necessarily fill in all items of the performance information 129 and may appropriately create the performance information 129. If all the items of the performance information 129 cannot be filled in, it is desirable to remove the blank items from the judgment targets using a policy (a performance policy).

In addition, the performance information 129 may be cached by the transmission apparatus 10 and used again. When the performance information 129 is cached and used, it is desirable to appropriately update the performance information 129. In that case, the timing at which the performance information 129 is updated is desirably a moment in which the configuration of networks included in the storage pool 1 has been changed or at certain intervals. In doing so, it is possible to reduce loads caused in the storage system 1 by creating the performance information 129.

The destination determination unit 123 determines a destination storage apparatus 10 from among the plurality of other storage apparatuses 10. The destination determination unit 123 determines the destination storage apparatus 10 of data from among the plurality of other storage apparatuses 10 on the basis of the performance information 129 and policies.

That is, the destination determination unit 123 determines the destination storage apparatus 10 on the basis of reception results of response frames transmitted from the other storage apparatuses 10 in response to investigation frames.

The policies herein refer to performance guarantee values between the host apparatus 2 and the destination storage apparatus 10 when the system is operated using the data in question.

The policies include a range policy (a transmission capability policy) and a performance policy (a processing capability policy).

The range policy is a selection standard based on the transmission capabilities between the transmission apparatus 10 and the other storage apparatuses 10 on the communication network 50 and used as a reference value. More specifically, the threshold value of the latency or the minimum throughput required for the destination storage apparatus 10 is set as the range policy. For example, the destination storage apparatus 10 is required to have latency equal to or less than a certain threshold value or a minimum throughput equal to or more than a certain threshold value. Such a threshold value is used as the range policy.

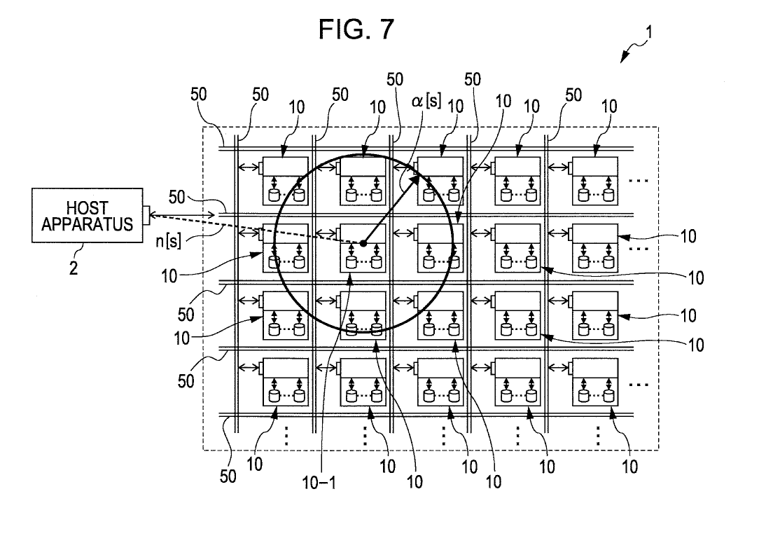

FIG. 7 is a diagram illustrating the latency as the range policy in the storage system 1 as an example of the first embodiment.

In the example illustrated in FIG. 7, a case will be considered in which a storage apparatus (transmission apparatus: hereinafter may be referred to as an initial storage apparatus) 10-1 that has received data from the host apparatus 2 for the first time moves the data to one of storage apparatuses (reception apparatuses) 10.

Latency α[s] is latency between the transmission apparatus 10-1 and the reception apparatuses 10. In the storage system 1, the latency a is used as the range policy (transmission capability policy). In FIG. 7, the range of the latency a around the transmission apparatus 10-1 is conceptually indicated by a circle drawn in a thick solid line.

In addition, latency from the host apparatus 2 to the transmission apparatus 10-1 is assumed to be N [s]. In this case, latency (distances) from the host apparatus 2 to the reception apparatuses 10 can be represented by an expression (N±α) [s], and the maximum value of the latency is represented by an expression (N+α).

As the latency N+α, a limit value up to which the performance of the system is guaranteed when the system is operated using the data in question or a value smaller than the limit value is set. Thus, the latency N+α expresses a range between the host apparatus 2 and the reception apparatuses 10 in which the performance of the system is guaranteed when the system is operated.

The latency N from the host apparatus 2 to the transmission apparatus 10-1 can be uniquely obtained. Therefore, by selecting a reception apparatus 10 included in the range of the latency a from the transmission apparatus 10-1, it is guaranteed that the latency required to operate the system is satisfied.

To be exact, the destination storage apparatus 10 of data transmitted from the transmission apparatus 10-1 is selected from among storage apparatuses 10 included in the range of the latency a around the transmission apparatus 10-1. Therefore, the latency of the destination storage apparatus 10 from the host apparatus 2 falls within the range of (N−α) to (N+α).

As described above, in the storage system 1, candidates for the destination storage apparatus 10 are selected (extracted) from among a plurality of storage apparatuses 10 using the latency from the transmission apparatus 10 as the range policy. In doing so, in the destination storage apparatus 10, too, it is possible to satisfy the latency required in relation to the host apparatus 2.

In addition, in the storage system 1, as the range policy, a minimum value required by the host apparatus 2 as the throughput is set to the minimum throughput as a threshold value in addition to the above-described latency.

Therefore, by selecting a storage apparatus 10 that satisfies the minimum throughput as the range policy as the destination storage apparatus 10, the destination storage apparatus 10 that satisfies the performance required by the host apparatus 2 as the throughput can be selected.

The performance policy is a selection standard based on the processing capabilities of the storage apparatuses 10. More specifically, the threshold value of the processing capabilities such as the IOPS, the throughput, the amount of available memory, and the like required for the storage apparatus 10 is set as the performance policy. For example, the destination storage apparatus 10 is required to have IOPS or a throughput equal to or more than a certain threshold value, and the threshold value is used as the performance policy.

The destination determination unit 123 refers to the performance information 129 on the basis of the range policy and the performance policy and determines a storage apparatus 10 that satisfies these policies as the destination storage apparatus 10.

Needless to say, when determining the destination storage apparatus 10, the destination determination unit 123 selects a storage apparatus 10 having an HDD 102 whose amount of available memory is larger than the size of data to be moved. The amount of available memory of each storage apparatuses 10 is checked by referring to the performance information 129.

The performance policy need not necessarily be set. When the performance policy has not been set, the destination determination unit 123 selects, for example, a storage apparatus 10 whose processing capabilities are higher than those of the transmission apparatus 10 from among candidates for the destination storage apparatus 10 extracted on the basis of the range policy and determines the selected storage apparatus 10 as the destination storage apparatus 10. If there is no storage apparatus 10 whose processing capabilities are higher than those of the transmission apparatus 10 among the candidates for the destination storage apparatus 10, it is desirable to abort the movement of data.

In addition, when there are a plurality of candidates for the destination storage apparatus 10, the destination determination unit 123 may preferentially determine a storage apparatus 10 whose processing capabilities such as the IOPS and the throughput are high among the plurality of candidates for the destination storage apparatus 10 as the destination storage apparatus 10.

Furthermore, a default value may be set in advance as the performance policy, and if the performance policy is not input, the default value may be used.

In addition, when determining the destination storage apparatus 10, the destination determination unit 123 may preferentially use a particular piece of information from among pieces of the processing capability information included in the performance information 129. For example, among the IOPSs for the four types of data sizes, namely 520 B, 4 kB, 64 kB, and 1 MB, the value of the IOPS for 520 B may be preferentially used. Similarly, among the throughputs for the four types of data sizes, namely 520 B, 4 kB, 64 kB, and 1 MB, the value of the throughput for 1 MB may be preferentially used.

As described above, the destination determination unit 123 determines the destination storage apparatus 10 on the basis of the reception results of the response frames and the policies in which the performance conditions required to process data are set.

The movement process unit 124 executes the movement process in which data is moved to the destination storage apparatus 10 determined by the destination determination unit 123. For example, the movement process unit 124 executes the movement of data by executing a known command for causing the storage apparatuses 10 to move the data.

In addition, when executing the movement of data, the movement process unit 124 records information (initial storage apparatus identification information and source information) for identifying a storage apparatus 10 (an initial storage apparatus 10) that has received the data from the host apparatus 2 in a certain region of a storage unit (for example, the HDD 102 or the memory 112) of the destination storage apparatus 10, while associating the information with information (data identification information) for identifying the data.

In each storage apparatus 10, the certain storage region of the HDD 102, the memory 112, or the like that stores the initial storage apparatus identification information functions as the source apparatus storage unit 132.

In addition, in the storage apparatus 10 (the initial storage apparatus 10) of the storage system 1 that receives data from the host apparatus 2 and stores the data for the first time, information for identifying the storage apparatus 10 itself is recorded as the initial storage apparatus identification information when the data has been received. The initial storage apparatus identification information in the initial storage apparatus 10 is also associated with the data identification information regarding the received data and recorded in the certain region of the HDD 102 or the memory 112.

Thus, in each storage apparatus 10 of the storage system 1, it is possible to easily identify the initial storage apparatus 10 by referring to the initial storage apparatus identification information regarding the storage apparatus 10 that has received data from the host apparatus 2 for the first time.

The checking unit 125 checks, with regard to data to be moved, whether or not the data is to be moved for the first time. The checking unit 125 checks whether or not the data to be moved is to be moved for the first time, that is, whether or not movement of data from the storage apparatus 10 (the initial storage apparatus 10) that has received the data from the host apparatus 2 to another storage apparatus 10 is performed for the first time. More specifically, the checking unit 125 checks the initial storage apparatus identification information associated with each piece of data and performs the check by comparing the initial storage apparatus identification information with the identification information recorded in each storage apparatus 10.

If it has been judged that the data to be moved is not to be moved for the first time as a result of the check performed by the checking unit 125, the destination determination request transmission unit 126 transmits a destination determination request to the storage apparatus 10 (the initial storage apparatus 10) identified by the initial storage apparatus identification information stored in the certain storage region of the storage apparatus 10.

The initial storage apparatus 10 to which the destination determination request has been transmitted by the destination determination request transmission unit 126 determines the destination storage apparatus 10 using the above-described functions as the investigation frame transmission unit 121, the performance information creation unit 122, and the destination determination unit 123. In the initial storage apparatus 10, the destination determination unit 123 notifies the storage apparatus 10 (a requesting storage apparatus 10) that has transmitted the destination determination request with the destination determination request transmission unit 126 of the determined destination storage apparatus 10 (a selected apparatus).

In the requesting storage apparatus 10 that has been notified of the selected apparatus, the movement process unit 124 moves the data and writes the initial storage apparatus identification information to the selected destination storage apparatus 10.

It is to be noted that the data to be moved may be first moved from the storage apparatus 10 (the requesting storage apparatus 10) that has transmitted the destination determination request with the destination determination request transmission unit 126 to the initial storage apparatus 10 and then transmitted from the initial storage apparatus 10 to the destination storage apparatus 10.

Alternatively, the movement of the data may be realized by the initial storage apparatus 10 by saving the data when the data has been received from the host apparatus 2 and transmitting the saved data to the determined destination storage apparatus 10 with the movement process unit 124. In this case, the data is deleted from the requesting storage apparatus 10 while the data is being transmitted from the initial storage apparatus 10 to the destination storage apparatus 10.

The measurement unit 130 investigates the processing capabilities and the status information of the corresponding storage apparatus 10. More specifically, the measurement unit 130 measures the RAID type, the IOPS, the throughput, the amount of available memory of the HDD 102, and the like. These pieces of information may be measured using various known methods, detailed description of which is omitted herein. Upon receiving an investigation frame from another storage apparatus 10, the measurement unit 130 begins to measure these pieces of information.

The response frame creation unit 131 creates a response frame using results of the measurement performed by the measurement unit 130.

The response frame creation unit 131 creates a response frame by using a sample response frame that has been created in advance in accordance with a certain format and that is stored in the HDD 102 or the memory 112 and by inputting the pieces of information measured by the measurement unit 130 to certain regions of the sample response frame.

That is, a response frame is created by storing the pieces of information measured by the measurement unit 130, such as the RAID type, the IOPS, the throughput, and the amount of available memory, in the sample response frame.

The response frame created by the response frame creation unit 131 is transmitted to the storage apparatus 10 that has transmitted the investigation frame.

In addition, the response frame creation unit 131 also measures the above-described time T2 (refer to FIG. 6) required to execute the process for creating a response frame, and adds the time T2 to the response frame as notification information.

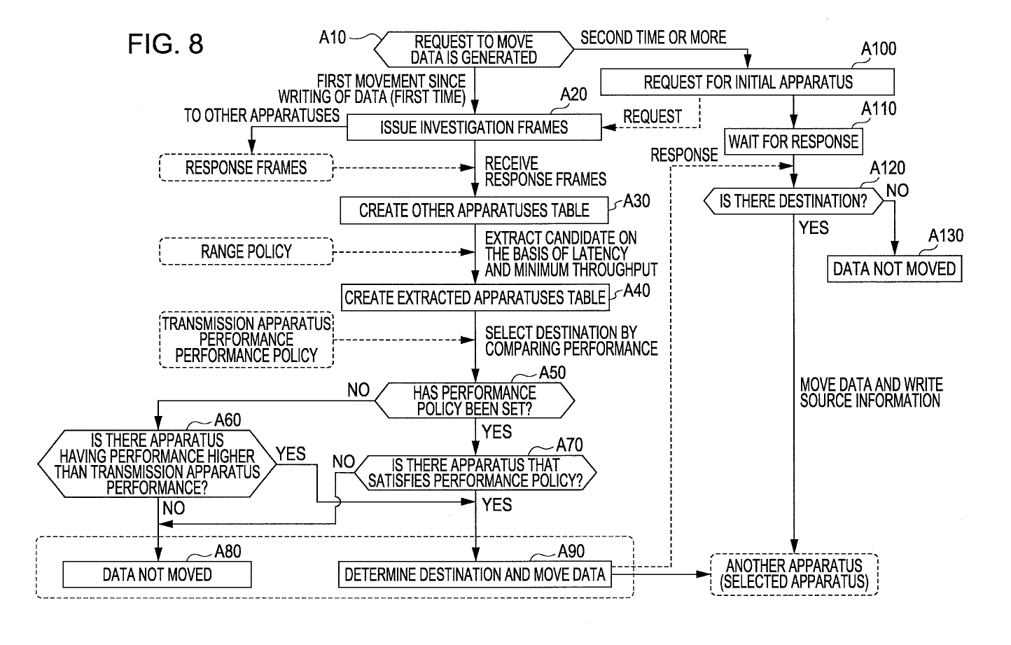

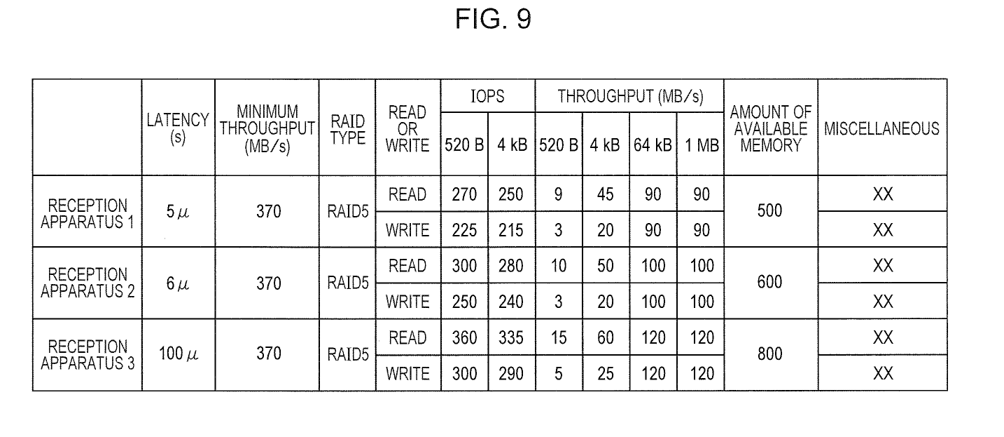

A process executed by the storage apparatus (transmission apparatus) 10 configured as described above in the storage system 1 as an example of the first embodiment will be described in accordance with a flowchart (steps A10 to A130) of FIG. 8 with reference to FIGS. 4 and 9.

FIG. 9 is a diagram illustrating an example of the performance information 129 in the storage system 1 as an example of the first embodiment.

It is to be noted that, in this example, a case will be described in which a movement request has been generated for data (data to be moved) having a data size of 100 MB stored in a RAID 5 of a certain storage apparatus 10.

In addition, as the range policy, “the latency is equal to or less than 10 μs” and “the minimum throughput is equal to or more than 300 MB/s” are set. The performance policy is not set.

In the example illustrated in FIG. 9, the performance information 129 is configured as a table (an other apparatuses table) in which the latency, the minimum throughput, the IOPS, the throughput, the amount of available memory, and other pieces of information are associated with one another for each of reception apparatuses 10-1 to 10-3 (reception apparatuses 1 to 3 in FIG. 9).

In the example illustrated in FIG. 9, only reception apparatuses whose RAID types are RAID 5 are illustrated for convenience sake.

When data stored in the certain storage apparatus 10 (transmission apparatus) is to be moved for a certain reason, a request to move the data is generated (step A10). The request to move the data is generated when, for example, the CPU 111 has detected that the use rate of a particular piece of data has become larger than a threshold value or when the operator has input a movement instruction.

In the storage apparatus 10, the checking unit 125 checks whether or not the data to be moved is to be moved for the first time.

If the movement of the data is to be performed for the second time or more since the data has been written from the host apparatus 2 (refer to a route “second time or more” in step A10), the destination determination request transmission unit 126 transmits a destination determination request (“request” in FIG. 8) to the initial storage apparatus 10 identified by the initial storage apparatus identification information (step A100). The requesting storage apparatus 10 then waits for a response with which the requesting storage apparatus 10 is notified of the destination storage apparatus 10 (the selected apparatus) by the initial storage apparatus 10 (step A110).

On the other hand, if the movement of the data is to be performed for the first time since the data has been written from the host apparatus 2 (refer to a route “first movement since writing of data” in step A10), the investigation frame transmission unit 121 of the initial storage apparatus 10 transmits investigation frames. The investigation frame transmission unit 121 transmits the investigation frames to a plurality of other storage apparatuses 10 connected through the communication network 50 (step A20).

In addition, in a case in which the destination determination request has been received from another storage apparatus 10 (the requesting storage apparatus 10) (refer to a route “request” in step A100), too, the investigation frame transmission unit 121 of the initial storage apparatus 10 transmits the investigation frames.

In each storage apparatus 10 that has received the investigation frame, the measurement unit 130 investigates the processing capabilities and the status information of the storage apparatus 10 and the response frame creation unit 131 creates a response frame on the basis of results of the investigation and transmits the response frame to the transmission apparatus 10.

The transmission apparatus 1 creates the performance information (the other apparatuses table) 129 on the basis of the response frames received from the storage apparatuses 10 (step A30).

The destination determination unit 123 refers to the performance information 129 and extracts storage apparatuses 10 that satisfy the range policy (the latency is equal to or less than 10 μs and the minimum throughput is equal to or more than 300 MB/s) as candidates for the destination storage apparatus 10. The destination determination unit 123 then creates an extracted apparatuses table including the extracted storage apparatuses 10 (step A40).

For example, in the example illustrated in FIG. 9, the latency of the reception apparatus 3 is 100 μs, which is larger than 10 μs required in the range policy. Therefore, the reception apparatus 3 is removed from the candidates for the destination storage apparatus 10.

The destination determination unit 123 checks whether or not the performance policy has been set (step A50). If the performance policy has not been set (refer to a route “no” in step A50), the destination determination unit 123 then checks whether or not there is a storage apparatus 10 whose performance is higher than that of the transmission apparatus 10 among the candidates for the destination storage apparatus 10 in the extracted apparatuses table by referring to the processing capability information in the performance information 129 (step A60). If there is no storage apparatus 10 whose performance is higher than that of the transmission apparatus 10 (refer to a route “no” in step A60), the destination determination unit 123 judges that there is no appropriate storage apparatus 10 to which the data is to be moved, and terminates the process without moving the data (step A80).

When the destination determination request has been received from the requesting storage apparatus 10 and the investigation frames have been issued, the destination determination request transmission unit 126 transmits a notification that there is no appropriate storage apparatus 10 to which the data is to be moved (there is no destination) to the storage apparatus 10 (the requesting storage apparatus 10) that has transmitted the request to move the data (refer to a route “response” in step A90).

On the other hand, if there is a storage apparatus 10 whose performance is higher than that of the transmission apparatus 10 (refer to a route “yes” in step A60), the destination determination unit 123 selects the storage apparatus 10 whose performance is higher than that of the transmission apparatus 10 as the destination storage apparatus 10 (step A90). If there are a plurality of candidates for the destination storage apparatus 10, the destination determination unit 123 preferentially determines a storage apparatus 10 whose processing capabilities such as the IOPS and the throughput are high among the plurality of candidates for the destination storage apparatus 10 as the destination storage apparatus 10.

In the example illustrated in FIG. 9, both the reception apparatus 10-1 and the reception apparatus 10-2 have processing capabilities such as IOPS and throughput higher than those of the transmission apparatus 10-X (illustrated as transmission apparatus X in FIG. 4) configured to have the processing capabilities illustrated in FIG. 4. Therefore, the destination determination unit 123 compares the reception apparatus 10-1 and the reception apparatus 10-2, and selects the reception apparatus 10-2, whose performance is higher, as the destination storage apparatus 10.

In addition, if the destination determination request has been received from the requesting storage apparatus 10 and the investigation frames have been issued, the destination determination request transmission unit 126 transmits a notification regarding the selected destination storage apparatus 10 (the selected apparatus) to the storage apparatus 10 (the requesting storage apparatus 10) that has transmitted the request to move the data (refer to the route “response” in step A90).

The movement process unit 124 moves the data and writes the initial storage apparatus identification information to the selected destination storage apparatus 10 (another apparatus, the selected apparatus). The process is then terminated.

If the performance policy has been set (refer to a route “yes” in step A50), whether or not there is a storage apparatus 10 that satisfies the performance policy among the candidates for the destination storage apparatus 10 in the extracted apparatuses table is checked (step A70). If there is no storage apparatus 10 that satisfies the performance policy (refer to a route “no” in step A70), the process proceeds to step A80.

If there is a storage apparatus 10 that satisfies the performance policy (refer to a route “yes” in step A70), the process proceeds to step A90. The destination determination unit 123 selects the storage apparatus 10 that satisfies the performance policy as the destination storage apparatus 10. If there are a plurality of candidates for the destination storage apparatus 10, the destination determination unit 123 preferentially determines a storage apparatus 10 whose processing capabilities such as the IOPS and the throughput are high among the plurality of candidates for the destination storage apparatus 10 as the destination storage apparatus 10.

The movement process unit 124 moves the data and writes the initial storage apparatus identification information to the selected destination storage apparatus 10 (another apparatus, the selected apparatus). The process is then terminated.

In addition, if the destination determination request has been received from the requesting storage apparatus 10 and the investigation frames have been issued, the destination determination request transmission unit 126 transmits the notification regarding the selected destination storage apparatus 10 (the selected apparatus) to the storage apparatus 10 (the requesting storage apparatus 10) that has transmitted the request to move the data (refer to the route “response” in step A90).

The requesting storage apparatus 10 checks whether or not the notification regarding the destination storage apparatus 10 is included in the response from the initial storage apparatus 10 (step A120). If the notification that there is no destination has been issued (refer to a route “no” in step A120), it is judged that there is no appropriate storage apparatus 10 to which the data is to be moved, and the process is terminated without moving the data (step A130).

If the notification regarding the destination storage apparatus 10 is included in the response from the initial storage apparatus 10 (refer to a route “yes” in step A120), the movement process unit 124 move the data and writes the initial storage apparatus identification information to the selected destination storage apparatus 10 (another apparatus, the selected apparatus). The process is then terminated.

As described above, according to the storage system 1 as an example of the first embodiment, the performance information 129 is created on the basis of the response frames transmitted in response to the investigation frames transmitted to other storage apparatuses 10. The destination storage apparatus 10 that satisfies the range policy is selected on the basis of the performance information 129.

Thus, a storage apparatus 10 that is within the range of the latency from the host apparatus 2, which has been defined in the range policy by the initial storage apparatus 10 that has written the data for the first time, is selected as the destination storage apparatus 10. Therefore, in the destination storage apparatus 10 to which the data is to be moved, too, the conditions such as the latency and the minimum throughput required in terms of the connection to the host apparatus 2 are satisfied. That is, after the data is moved, a failure due to the latency or the minimum throughput, such as timeout, is not generated in the destination storage apparatus 10 when the host apparatus 2 has accessed the destination storage apparatus 10, thereby improving the stability and the reliability.

In addition, since the destination determination unit 123 determines a storage apparatus 10 that satisfies the performance policy as the destination storage apparatus 10, a storage apparatus 10 that satisfies a processing capability standard required for the destination storage apparatus 10 is determined as the destination storage apparatus 10 in advance.

Therefore, the storage apparatus 10 that meets the requirements such as the IOPS, the throughput, and the amount of available memory can be used as the destination storage apparatus 10, and therefore a decrease in the performance due to the movement of data does not occur in the storage system 1.

In addition, when there are a plurality of candidates for the destination storage apparatus 10, the destination determination unit 123 selects a storage apparatus 10 whose processing capabilities are higher than those of the transmission apparatus 10 and determines the storage apparatus 10 as the destination storage apparatus 10. Therefore, in accordance with the movement of data, the processing capabilities can be improved in comparison with those before the movement of the data, whereas effects caused by the movement of the data on the host apparatus 2 can be reduced.

Furthermore, when there are a plurality of candidates for the destination storage apparatus 10, the destination determination unit 123 preferentially determines a storage apparatus 10 whose processing capabilities such as the IOPS and the throughput are high among the plurality of candidates for the destination storage apparatus 10 as the destination storage apparatus 10. Therefore, it is possible to prevent a decrease in the processing capabilities caused by the movement of data.

In addition, when the same data is to be moved for the second time or more, the destination determination request transmission unit 126 causes the initial storage apparatus 10 to determine the destination storage apparatus 10. Accordingly, the destination storage apparatus 10 that satisfies the range policy such as the latency in relation to the initial storage apparatus 10 is determined. Therefore, the conditions such as the latency and the minimum throughput required in terms of the connection to the host apparatus 2 can be satisfied in the destination storage apparatus 10.

### Second Embodiment

The present invention is not limited to the above-described first embodiment, and may be modified in various ways and implemented, insofar as the scope thereof is not deviated from.

A plurality (N) of host apparatuses 2 are connected to a storage system 1 as an example of a second embodiment. It is to be noted that the same or substantially the same components are given the same reference numerals as those used above, and therefore detailed description thereof is omitted.

In the second embodiment, when the process for moving data is executed, the measurement unit 130 measures the latency and the minimum throughputs of each storage apparatus 10 that has received an investigation frame from the investigation frame transmission unit 121 of the transmission apparatus 10 in relation to the host apparatuses 2 that access the data to be moved. That is, in the storage system 1 according to the second embodiment, each measurement unit 130 measures connection capabilities in relation to the plurality of host apparatuses 2.

The connection capabilities are information indicating transmission capabilities between a reception apparatus 10 and a host apparatus 2 that is connected to the reception apparatus 10 through the communication network 50, and are, for example, transmission latency and minimum throughput.

In the second embodiment, investigation frames cause storage apparatuses (reception apparatuses) 10 that have received the investigation frames to investigate the processing capabilities, the status information, and the connection capabilities in relation to the host apparatuses 2 of the storage apparatuses 10.

In addition, the investigation frames cause the reception apparatuses 10 that have received the investigation frames to create response frames storing the processing capability information indicating the processing capabilities of the reception apparatuses 10, the status information, and connection capability information indicating the connection capabilities, and to send the response frames back to the storage apparatus 10 (the transmission apparatus) that has transmitted the investigation frames.

For example, the investigation frames are configured as data strings having a particular format that has been defined in advance, and cause the reception apparatuses 10 that have received the investigation frames to execute a function of investigating the processing capabilities, the status information, and the connection capabilities, a function of creating response frames, and a function of transmitting the response frames. The investigation frames may be configured as a combination between an investigation instruction command, a creation instruction command, and a transmission instruction command that cause the storage apparatuses 10 that have received the investigation frames to investigate the processing capabilities and the connection capabilities, to create response frames, and to transmit the response frames, respectively.

The host apparatuses 2 in relation to which the connection capabilities are to be measured may be determined by, for example, referring to a configuration table or the like included in a management apparatus (not illustrated) that manages the storage pool 1. Alternatively, all host apparatuses 2 that are connected through the communication network 50 may be determined to be the targets. When all the host apparatuses 2 that are connected through the communication network 50 are determined to be the targets, requests to investigate the connection capabilities are transmitted using a method such as, for example, broadcast. Alternatively, the host apparatuses 2 in relation to which the connection capabilities are to be measured may be determined by the transmission apparatus 10 and information regarding the host apparatuses 2 in relation to which the connection capabilities are to be measured may be transmitted at the same time as the investigation frames.

In each reception apparatus 10, upon receiving an investigation frame, the measurement unit 130 transmits second investigation frames to the host apparatuses 2 in relation to which the connection capabilities are to be measured. The measurement unit 130 then obtains the latency and the minimum throughputs between the corresponding reception apparatus 10 and the host apparatuses 2 on the basis of second response frames transmitted from the host apparatuses 2 in response to the second investigation frames.

The calculation of the latency and the minimum throughputs in relation to the host apparatuses 2 performed by the measurement unit 130 on the basis of the second investigation frames and the second response frames may be realized by applying the above-described method using the expressions (1) and (2) based on the investigation frames and the response frames in the same manner as above.

That is, as the moment T3, the moment T1, and the time T2, a moment in which each reception apparatus 10 receives the second response frame, a moment in which the second investigation frame is received from each reception apparatus 10, and time required for a host apparatus 2 to execute the process for creating the second response frame, respectively, are used.

In addition, the time T2 required for a host apparatus 2 to execute the process for creating the second response frame is measured by the host apparatus 2 itself, and the time T2 is added to the second response frame as notification information and transmitted to each reception apparatus 10.

In each reception apparatus 10, the measurement unit 130 transmits the second investigation frame to each host apparatus 2, in order to obtain the latency and the minimum throughput in relation to each host apparatus 2. In addition, the information regarding the connection capabilities in relation to each host apparatus 2 is added to the response frame and transmitted to the transmission apparatus 10.

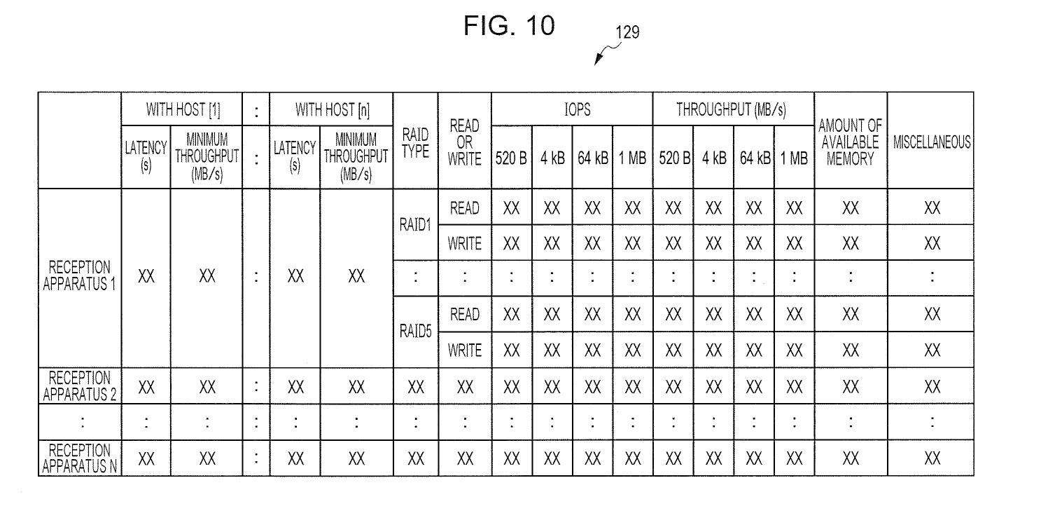

FIG. 10 is a diagram illustrating performance information 129 in the storage system 1 as an example of the second embodiment.

In the storage system 1 according to the second embodiment, the performance information creation unit 122 creates the performance information 129 illustrated in FIG. 10. The performance information 129 illustrated in FIG. 10 includes the transmission capability information (the latency and the minimum throughput) between each reception apparatus 10 and each host apparatus 2, instead of the transmission capability information (the latency and the minimum throughput) included in the performance information 129 according to the first embodiment illustrated in FIG. 5. In FIG. 10, too, each value is expressed as “XX” as in FIG. 5. In practice, various values are stored instead of “XX”.

In the storage system 1 according to the second embodiment, the destination determination unit 123 determines the destination storage apparatus 10 on the basis of the performance information 129 illustrated in FIG. 10 and the policies (the range policy and the performance policy).

More specifically, in the storage system 1 according to the second embodiment, the destination determination unit 123 determines a storage apparatus 10 whose latency in relation to the plurality of host apparatuses 2 is equal to or less than a certain value as the destination storage apparatus 10.

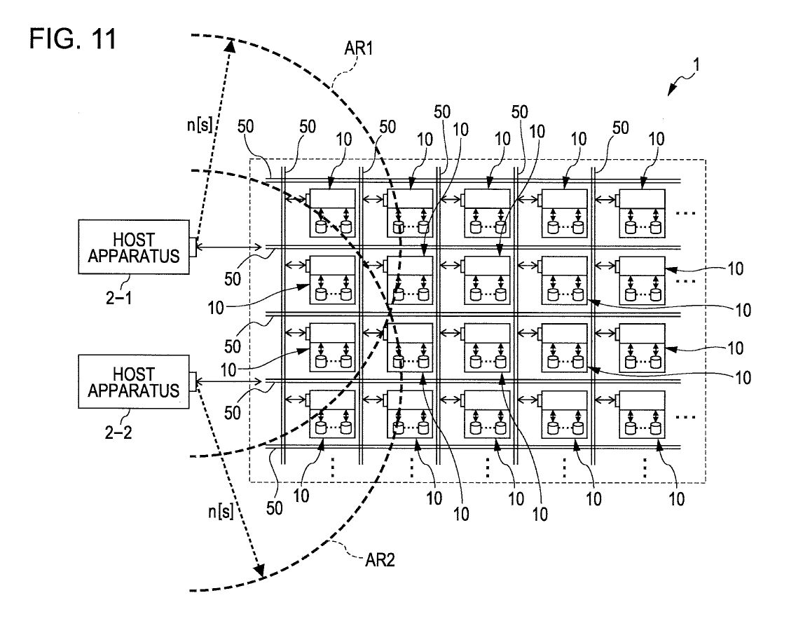

FIG. 11 is a diagram illustrating a method for using the latency as the range policy in the storage system 1 as an example of the second embodiment. In the example illustrated in FIG. 11, two host apparatuses 2-1 and 2-2 are illustrated for convenience sale.

The destination determination unit 123 extracts storage apparatuses 10 whose latency in relation to the host apparatus 2-1 is equal to or less than latency N [s] (refer to a range AR1 in FIG. 11) and whose latency in relation to the host apparatus 2-2 is equal to or less than latency N [s] (refer to a range AR2 in FIG. 11) as candidates for the destination storage apparatus 10 (refer to an overlap portion between the range AR1 and the range AR2 in FIG. 11).

The latency N in relation to the host apparatuses 2 to be used for the extraction of the candidates for the destination storage apparatus 10 may be appropriately selected. For example, the above-described value of latency from the host apparatus 2 to the initial storage apparatus 10 may be used.

In addition, although, in the second embodiment, the storage apparatuses 10 whose latency in relation to the plurality of host apparatuses 2 is equal to or less than the same latency (N) are extracted as the candidates for the destination storage apparatus 10, the present invention is not limited to this. For example, a different value of latency may be used for at least some host apparatuses 2. Various modifications may be implemented.

The destination determination unit 123 determines the destination storage apparatus 10 from among the candidates for the destination storage apparatus 10 extracted in the above-described manner on the basis of the latency in relation to the plurality of host apparatuses 2 by applying the method used in the first embodiment. That is, a storage apparatus 10 that satisfies the range policy and the performance policy is determined as the destination storage apparatus 10 from among the storage apparatuses 10 whose latency in relation to the plurality of host apparatuses 2 is equal to or less than the certain value of latency.

Thus, according to the storage system 1 as an example of the second embodiment, the same operational effects can be obtained as in the above-described first embodiment, and the destination storage apparatus 10 is located within the certain value of latency in relation to the plurality of host apparatuses 2. That is, a storage apparatus 10 that is located within the certain value of latency in relation to the plurality of host apparatuses 2 is selected as the destination storage apparatus 10. Therefore, after the data is moved, a failure due to the latency or the minimum throughput, such as timeout, is not generated in the destination storage apparatus 10 when any host apparatus 2 has accessed the destination storage apparatus 10, thereby improving the stability and the reliability.

The technique disclosed herein is not limited to the above-described embodiments, and may be modified in various ways and implemented, insofar as the scope thereof is not deviated from.

For example, although the performance information 129 and the source apparatus information are stored in the memory 112 in the above-described embodiments, the present invention is not limited to this. The created performance information 129 may be stored in another storage device such as the HDD 102.

In addition, in the above-described embodiments, pieces of information used as the performance information 129 are not limited to the latency, the minimum throughput, the IOPS, the throughput, and the amount of available memory. That is, only some of these pieces of information may be used, or information other than these pieces of information may be used. In addition, the data sizes used to indicate the IOPS and the throughput are not limited to those described in the above embodiments and may be changed in various ways and used.

Furthermore, although, in the above-described second embodiment, the storage apparatus 10 whose latency in relation to the two host apparatuses 2-1 and 2-2 is equal to or less than the certain value of latency is selected as the destination storage apparatus 10, the present invention is not limited to this. That is, a storage apparatus 10 whose latency in relation to three or more host apparatuses 2 is equal to or less than a certain value of latency may be selected as the destination storage apparatus 10.

The embodiments can be implemented or manufactured by those skilled in the art on the basis of the above-described disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. A storage apparatus comprising:
a storage unit that stores received data;
an investigation frame transmission unit that transmits investigation frames to a plurality of other storage apparatuses connected through a communication network;
a performance information creation unit that creates performance information for the plurality of other storage apparatuses on the basis of reception results of response frames transmitted in response to the investigation frames;
a destination determination unit that determines a destination storage apparatus from among the plurality of other storage apparatuses on the basis of the created performance information; and
a movement process unit that executes a movement process in which the data is moved from the storage unit to the destination storage apparatus.

2. The storage apparatus according to claim 1,
wherein the destination determination unit determines the destination storage apparatus on the basis of the performance information generated on the basis of the reception results of the response frames and policies in which performance conditions required to process the data have been set in advance.

3. The storage apparatus according to claim 2,
wherein the policies include
a transmission capability policy relating to transmission capabilities between the storage apparatus and the other storage apparatuses on the communication network, and
a processing capability policy relating to processing capabilities of the other storage apparatuses.

4. The storage apparatus according to claim 3,
wherein, when the processing capability policy has not been set, the destination determination unit determines a storage apparatus whose processing capabilities are higher than those of a source storage apparatus as the destination storage apparatus.

5. The storage apparatus according to claim 3,
wherein, when there are a plurality of candidates for the destination storage apparatus, the destination determination unit preferentially determines a storage apparatus whose processing capabilities are high among the plurality of candidates for the destination storage apparatus as the destination storage apparatus.

6. The storage apparatus according to claim 3,
wherein each of the other storage apparatuses includes
a measurement unit that measures connection capabilities in relation to a host, and
a response frame creation unit that stores connection capability information indicating the connection capabilities in each of the response frames, and
wherein the policies include
a connection capability policy relating to the connection capabilities between the host and the storage apparatus.

7. The storage apparatus according to claim 1,
wherein the performance information includes
transmission capability information indicating transmission capabilities between the storage apparatus and the other storage apparatuses on the communication network, and
processing capability information indicating processing capabilities of the other storage apparatuses.

8. The storage apparatus according to claim 1, further comprising:
a source apparatus storage unit that, when the data is to be moved to the destination storage apparatus, stores information for identifying a storage apparatus that has received the data from a host for the first time;
a checking unit that checks whether or not the data is to be moved for the first time; and
a destination determination request transmission unit that, if the data is not to be moved for the first time, transmits a destination determination request to the storage apparatus stored by the source apparatus storage unit.

9. A method for moving data among a plurality of storage apparatuses having storage units that store received data, the method comprising:
transmitting investigation frames from a storage apparatus to a plurality of other storage apparatuses connected through a communication network;
creating performance information for the plurality of other storage apparatuses on the basis of reception results of response frames transmitted in response to the investigation frames;
determining a destination storage apparatus from among the plurality of other storage apparatuses on the basis of the created performance information; and
executing a movement process in which the data is moved from the storage unit to the destination storage apparatus.

10. The method for moving data according to claim 9,
wherein, in the step of determining the destination storage apparatus, the destination storage apparatus is determined on the basis of the reception results of the response frames and policies in which performance conditions required to process the data have been set in advance.

11. The method for moving data according to claim 10,
wherein the policies include
a transmission capability policy relating to transmission capabilities between the storage apparatus and the other storage apparatuses on the communication network, and
a processing capability policy relating to processing capabilities of the other storage apparatuses.

12. The method for moving data according to claim 11,
wherein, in the step of determining the destination storage apparatus, when the processing capability policy has not been set, a storage apparatus whose processing capabilities are higher than those of a source storage apparatus is determined as the destination storage apparatus.

13. The method for moving data according to claim 11,
wherein, in the step of determining the destination storage apparatus, when there are a plurality of candidates for the destination storage apparatus, a storage apparatus whose processing capabilities are high among the plurality of candidates for the destination storage apparatus is preferentially determined as the destination storage apparatus.

14. The method for moving data according to claim 11,
wherein each of the other storage apparatuses executes the steps of:
measuring connection capabilities in relation to a host, and
storing connection capability information indicating the connection capabilities in each of the response frames, and
wherein the policies include
a connection capability policy relating to the connection capabilities between the host and the storage apparatus.

15. The method for moving data according to claim 9,
wherein the performance information includes
transmission capability information indicating transmission capabilities between the storage apparatus and the other storage apparatuses on the communication network, and
processing capability information indicating processing capabilities of the other storage apparatuses.

16. The method for moving data according to claim 9, further comprising the steps of:
storing, when the data is to be moved to the destination storage apparatus, information for identifying a storage apparatus that has received the data from a host for the first time in a source apparatus storage unit;
checking whether or not the data is to be moved for the first time; and
transmitting, when the data is not to be moved for the first time, a destination determination request to the storage apparatus stored by the source apparatus storage unit.

17. A storage system comprising:
a plurality of storage apparatuses connected to one another through a communication network, the storage apparatuses each including:
a storage unit that stores received data; and
a processor to execute a process, the process including:
transmitting investigation frames to the other storage apparatuses connected through the communication network;
creating performance information for the plurality of other storage apparatuses on the basis of reception results of response frames transmitted in response to the investigation frames;
determining a destination storage apparatus from among the plurality of other storage apparatuses on the basis of the created performance information; and
executing a movement process in which the data is moved from the storage unit to the destination storage apparatus.
